(19) United States
(12) Patent Application Publication
(10) Pub. No.: US 2011/0175025 A1
(43) Pub. Date: Jul. 21, 2011

(54) TURBOCHARGER AND SUBASSEMBLY FOR BYPASS CONTROL IN THE TURBINE CASING THEREFOR

(75) Inventor: Gerald Schall, Bobenheim-Roxheim (DE)

(73) Assignee: BORGWARNER INC., Auburn Hills, MI (US)

(21) Appl. No.: 13/062,737

(22) PCT Filed: Sep. 15, 2009
(86) PCT No.: PCT/US09/56893

§ 371 Date: Mar. 25, 2011

(30) Foreign Application Priority Data
Sep. 25, 2008 (DE) 102008048884.4

(51) Int. Cl. C09K 3/00

(52) U.S. Cl. 252/182.33

(57) ABSTRACT

The invention relates to a subassembly for bypass control in the turbine casing of a turbocharger, in particular in a diesel engine, and to an exhaust gas turbocharger with a subassembly for bypass control in the turbine casing of the turbocharger.

The invention relates to a subassembly for bypass control in the turbine casing of a turbocharger, in particular in a diesel engine, according to the preamble of claim 1, and also to an exhaust gas turbocharger with a subassembly for bypass control in the turbine casing of the turbocharger, according to the preamble of claim 10.

Exhaust gas turbochargers are systems for increasing the power of piston engines. In an exhaust gas turbocharger, the energy of the exhaust gases is used for increasing the power. The power increase results from a rise in the mixture throughput per working stroke.

A turbocharger consists essentially of an exhaust gas turbine with a shaft and with a compressor, the compressor arranged in the intake tract of the engine being connected to the shaft, and the blade wheels located in the casing of the exhaust gas turbine and in the compressor rotating.

Exhaust gas turbochargers are known which allow multi-stage, that is to say at least two-stage supercharging, so that even more power can be generated from the exhaust gas jet. Such multi-stage exhaust gas turbochargers have a special set-up which comprises a regulating member for highly dynamic cyclic stresses, to be precise a subassembly for bypass control in the turbine casing of the exhaust gas turbocharger, such as, for example, in particular a flap plate, a lever or a spindle.

The subassembly for bypass control in the turbine casing of the exhaust gas turbocharger has to satisfy extremely stringent material requirements. The material forming the individual components of the subassembly for bypass control must be heat-resistant, that is to say still offer sufficient strength even at very high temperatures of at least up to about 850° C. Furthermore, the material must have good resistance to the break-up of grain boundaries during casting. If the material is resistant to the break-up of grain boundaries, complex filling geometries, even with thin wall thicknesses, can consequently be implemented during precision casting, this being a decisive criterion particularly in the case of the fine geometric parts of the subassembly for bypass control in the turbine casing of an exhaust gas turbocharger. Furthermore, the ductility of the material must be sufficiently high, so that, under overload, the parts are not subjected to plastic deformation and do not break.

An exhaust gas turbocharger with a double-flow exhaust gas inlet duct is known from DE 10 2007 018 617 A1.

The object of the present invention, then, was to provide a subassembly for bypass control in the turbine casing of a turbocharger, according to the preamble of claim 1, and a turbocharger according to the preamble of claim 10, which has improved temperature resistance and is distinguished by good resistance to the break-up of the grain boundaries during the casting of the material. Moreover, the subassembly for bypass control should have high ductility, be stable and have low susceptibility to wear.

The object is achieved by means of the features of claim 1 and of claim 10.

What is achieved by the design according to the invention of the subassembly for bypass control in the turbine casing of a turbocharger, consisting of an iron-based alloy with a carbide microstructure and dispersions of at least one element or one compound of the “rare earths” and/or Y₂O₃, is that the material which ultimately provides the subassembly for bypass control in the turbine casing is distinguished by especially good strength and stability. The stability of the material according to the invention is promoted, in particular, in that the material has high resistance to the break-up of grain boundaries. It is presumed that the grain boundary cohesion is increased by means of at least one element and/or one compound of the “rare earths” or Y₂O₃. It seems that it is precisely these chemical elements which are elements effective in terms of grain boundaries and bring about a stabilization of the material even during its production.

Without being involved in theory, it is presumed that it is precisely the iron-based alloy according to the invention with a carbide microstructure which has a property profile balanced for the intended use, to be precise sufficient strength along with very good ductility. Furthermore, the material is distinguished by high stability and therefore low wear, even under load at high temperatures, that is to say temperatures of up to 870° C.

It has been shown that dispersions into the iron-based alloy of at least one element or one compound of the “rare earths” and/or Y₂O₃ counteract the lattice slip under high-temperature conditions, thus additionally bringing about a stabilization of the material, in that the break-up of the grain boundaries is prevented or markedly reduced. Moreover, the fine dispersoids of the elements or compounds of the “rare earths” and/or of the Y₂O₃ reinforce the dislocation anchoring, so that, during the casting of the material and the generation of the final form, the material is so stable that even complex filling geometries, even with extremely thin wall thicknesses, can be produced.

The subassembly according to the invention is distinguished by a temperature resistance of up to 870° C., which is attributable to the unique composition of the material and the balanced ratio in the iron alloy which has a carbide microstructure, in combination with at least one element or one compound of the “rare earths” and/or Y₂O₃.

Furthermore, the long-term rupture strength of the subassembly according to the invention for bypass control in the turbine casing of a turbocharger is considerably improved.

The subassembly according to the invention for bypass control in the turbine casing of a turbocharger is understood to mean all structural parts which are part of the regulating member for the highly dynamic cyclic stress, in particular a flat plate, lever, bush or spindle. The subassembly according to the invention for bypass control is preferably one which is employed in a multi-stage or at least two-stage exhaust gas turbocharger.

The term “rare earths” is understood to mean all elements which are gathered together in the periodic system of elements under the definition “lanthanoids”, that is to say essentially lanthanum, cerium, praseodymium, samarium, europium, gadolinium, terbium, dysprosium, holmium, erbium, thulium, ytterbium and lutetium.

The term “element” is to be understood as meaning both the pure chemical element and compounds thereof, in particular its oxides.

The subclaims contain advantageous developments of the invention.

Thus, in one embodiment, by the addition of boron and/or zirconium to the iron-based alloy, the formation of bead-like carbide films on the grain boundaries can be counteracted or their formation prevented. In addition, by means of the element boron, a lowering of the solidus line, that is to say of the transformation line from □- to □-structures, is achieved, with the result that the material gains further stability and therefore strength.

In a further embodiment, the subassembly according to the invention is distinguished in that the iron-based alloy contains the elements titanium, tantalum and carbon (Ti, Ta, C) with a total fraction of about 5 to 10% by weight in relation to the overall weight of the iron-based alloy, that is to say of the overall alloy. By means of these elements, the precipitation hardness and the formation of intermetallic compounds in the material are increased. In particular, the precipitation hardening achieves a higher nominal strength, so that the material matrix undergoes thermodynamic shrinkage amplitudes which are less plastic than elastic. The result is higher oscillatory strength, that is to say a marked increase in the resistance of the material under load. Too high a fraction of the elements titanium, tantalum and carbon, that is to say greater than 10% by weight, reduces the strength of the material again due to secondary precipitations of carbide formations. The elasticity of the material increases again, and therefore a sufficient stability of the workpiece cannot be ensured in the long term. The structural parts suffer distortion. In the case of a fraction of Ti, Ta and C of less than 5% by weight in relation to the overall weight of the alloy, the stabilizing fraction of intermetallic compounds is too low to achieve an improved stability of the workpiece.

In a further embodiment, the subassembly according to the invention is distinguished in that the iron-based alloy contains the elements lanthanum and hafnium, their fraction by volume amounting in total to a maximum of 2% by volume in relation to the overall volume of the overall alloy. By means of such a fraction by volume of the two elements, the ductility of the material is once more markedly increased. Furthermore, the cohesion and adhesion ratios at the grain boundaries and in the matrix are reinforced, so that a break-up of the grain boundaries during the casting of the material is prevented even more effectively, or the break-up is markedly reduced. A fraction by volume of more than 2% by volume of the elements lanthanum and hafnium, moreover, does not afford any renewed marked increase in ductility and is therefore not profitable.

In a further embodiment, the subassembly according to the invention is characterized in that the iron-based alloy contains the elements lanthanum, hafnium, boron, yttrium and zirconium. As already stated, Y₂O₃ is a highly temperature-resistant dispersoid which tends to strong dislocation anchorings and at the same time improves the covering layer adhesion, with the result that even the oxidation resistance is increased. The element zirconium is also an element effective in terms of grain boundaries. It additionally reduces the intercrystalline grain growth and consequently increases the ductility and the long-term rupture strength of the material once more by a multiple. At the same time, zirconium prevents the formation of carbide films on the grain boundaries, which may lead to instability of the material and to the break-up of the grain boundaries. Surprisingly, then, it was found that, precisely in combination, the elements La, Hf, B, Y and Zr markedly counteract the dislocation tendency within the material matrix and thereby increase the strength of the workpiece, and therefore the susceptibility of the material to wear is markedly reduced. This means that the structural parts experience a significant positive time delay in terms of a break induced by load fluctuations. Useful life of the structural parts can consequently once more be increased markedly.

In a further embodiment, the subassembly according to the invention for bypass control in the turbine casing of a turbocharger is distinguished additionally by an improved hot-gas corrosion performance. This is established, according to the invention, via the elements titanium, tantalum, chrome and cobalt. In this embodiment, their total fraction amounts to about 22 to 35% by weight in relation to the overall weight of the alloy. In the case of a lower content, that is to say of less than about 22% by weight, the hot-gas corrosion performance cannot be achieved so well. In the case of a content of more than 35% by weight of the elements specified, there is again a contrary effect and the hot-gas corrosion performance deteriorates again.

According to a further embodiment, the subassembly for bypass control is distinguished by a specific composition of the iron-based alloy which contains the following components: C: 0.05 to 0.35% by weight, Cr: 17 to 26% by weight, Ni: 15 to 22% by weight, Co: 15 to 23% by weight, Mo: 1 to 4% by weight, N: 1.5 to 4% by weight, Ta: 1 to 3.5% by weight, Zr: 0.1 to 0.5% by weight, Hf: 0.4 to 1.2% by weight, B: maximum 0.2% by weight, La: maximum 0.25% by weight, Si: maximum 1% by weight, Mn: 1 to 2% by weight, Nb: 0.5 to 2% by weight, Ti: 1 to 2.5% by weight, N: 0.1 to 0.5% by weight, the sum of S and P: less than 0.04% by weight, and iron.

The influence of the individual elements on an iron-based alloy is known, but it was surprisingly found, then, that precisely the combination described affords a material which, when processed into a structural part of the subassembly for bypass control in the turbine casing of a turbocharger, gives this a particularly balanced property profile. As a result of this composition according to the invention, a structural part having especially high resistance to the break-up of the grain boundaries during casting is obtained, which, moreover, is distinguished by high strength, while at the same time having very good values for ductility. The solidus line is markedly lowered. The structural parts are distinguished by a highly positive time delay for an “LCF break”, a break under the action of load fluctuations, with the result that the useful life of the structural parts is markedly increased.

Alternatively to this specific composition, the subassembly for bypass control may also be distinguished by the following further specific composition of the iron-based alloy which contains the following components: C: 0.05 to 0.35% by weight, Cr: 17 to 26% by weight, Ni: 15 to 22% by weight, Co: 15 to 23% by weight, Mo: 1 to 4% by weight, N: 1.5 to 4% by weight, Ta: 1 to 3.5% by weight, Zr: 0.1 to 0.5% by weight, Y₂O₃: 0.4 to 1.5% by weight, Ti: 1.5 to 3% by weight, Si: maximum 1% by weight, Mn: 0.8 to 2.5% by weight, Nb: 0.5 to 1.7% by weight, N: 0.05 to 0.5% by weight, the sum of S and P: less than 0.05% by weight, andiron.

A structural part consisting of an iron-based alloy of this type is also distinguished by the good properties specified above.

Thus, a material which has been produced according to the two specific compositions has the following properties:

| Mechanical Property | Value | | Measuring method |
|---|---|---|---|
| Tensile strength Rₘ | 850 to 1070 | MPa | ASTM E 8M/EN |
| | | | 10002-1; at |
| | | | increased |
| | | | temperature: EN |
| | | | 10002-5 |
| Yield strength Rₚ _{0.2} | 680 to 770 | MPa | Standard method |
| Elongation at break | >15% | | Standard method |
| Hardness | 290-365 | HB | ASTM E 92/ISO |
| | | | 6507-1 |

According to a further embodiment of the invention, the subassembly according to the invention for bypass control or its iron-based alloy is free of sigma phases. This counteracts the embrittlement of the material and increases its durability. Sigma phases are brittle sintermetallic phases of high hardness. They arise when a body-centered and a face-centered cubic metal, the atomic radii of which are identical with only a slight deviation, meet one another. Such sigma phases are undesirable because of their embrittling action and also on account of the property of the matrix to remove chrome. The material according to the invention is distinguished in that it is free of sigma phases. Consequently, the embrittlement of the material is counteracted and its durability is increased. The reduction or avoidance of the formation of sigma phases is achieved in that the silicon content in the alloy material is lowered to less than 1.3% by weight and preferably to less than 1% by weight. Furthermore, it is advantageous to employ austenite formers, such as, for example, manganese, nitrogen and nickel, if appropriate in combination.

According to the invention, the iron-based alloy, on which the subassembly according to the invention for bypass control in the turbine casing of a turbocharger is based, may be produced by means of precision casting or the MIN method. The respective materials are to be welded by means of conventional WIG plasma methods and also EB methods. Heat treatment takes place by solution annealing at about 1030 to 1050° C. for 8 hours in a vacuum. Precipitation hardening takes place at about 720° C. for 16 hours with air-cooling in a batch furnace.

Claim 10 defines, as an independently handleable article, an exhaust gas turbocharger which comprises a subassembly for bypass control in the turbine casing of an exhaust gas turbocharger, as already described, which consists of an iron-based alloy with a carbide microstructure and dispersions of at least one element or one compound of the “rare earths” and/or Y₂O₃.

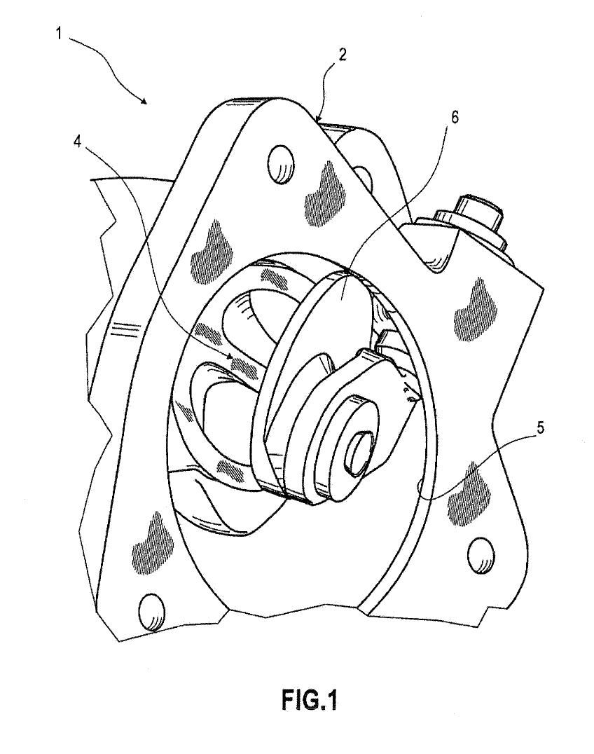

FIG. 1 shows a partial illustration of the turbocharger 1 according to the invention in one embodiment, which does not need to be described in any more detail with regard to the compressor, the compressor casing, the compressor shaft, the bearing casing and the bearing arrangement and also all other conventional parts. A two-stage exhaust gas inlet duct cannot be seen here. The exhaust gas inlet duct is provided with a double-flow bypass duct 4 which branches off from the exhaust gas inlet duct and which leads to an exhaust gas outlet 5 of the turbine casing 2. The bypass duct 4 has a regulating flap 6 for opening and closing.

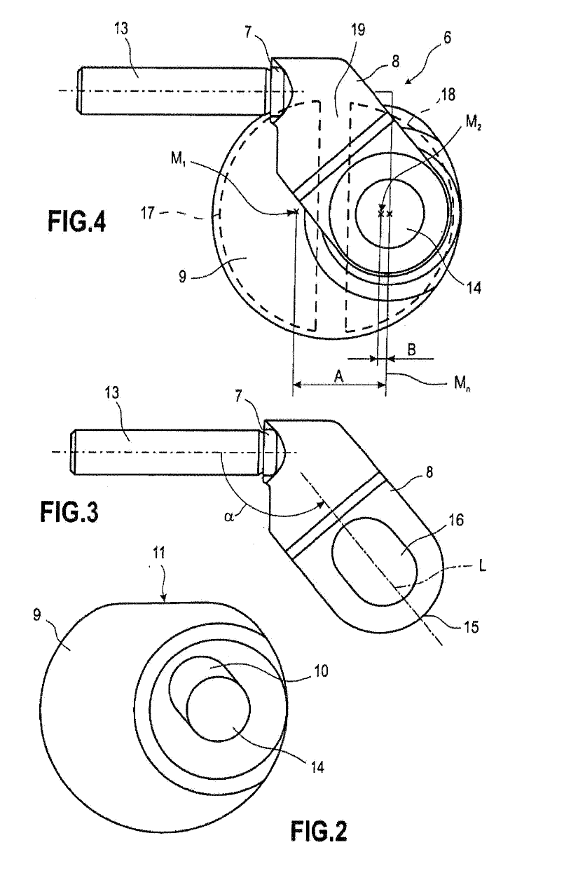

FIG. 2 shows a top view of the flap plate 9 of the regulating flap 6 of the turbocharger 1, the flap plate 9 being circular in this embodiment, although it may, in general, also have flattened regions 11. The flap plate 9 has, furthermore, on its topside an elliptic fastening tenon 10 which is attached eccentrically to the flap plate 9 and on which a fastening head 14 is arranged.

FIG. 3 shows a top view of the fastening lever 8 and the spindle 13 of the regulating flap 6. The fastening lever 8 is fastened to the spindle 13 at a free end 7. The spindle 13 is angularly connected to an actuating member, not illustrated in any more detail, for the actuation of the regulating flap 6. As illustrated in FIG. 3, the fastening lever 8 is of plate-shaped design and is oriented at a freely selectable angle □ (here 130°) to the spindle 13. The fastening lever 8 has, in the region of its free end 15, a reception recess 16, the form of which is elliptic here, so that it corresponds to the elliptic form of the fastening tenon 10 of the flap plate 9.

FIG. 4 shows a top view of the regulating flap 6 composed of the fastening lever 8 and of the flap plate 9. FIG. 4 illustrates the mounted regulating flap 6 in which the fastening tenon 10 is arranged in the reception recess 16 and the arrangement is fixed by means of the fastening head 14. Furthermore, FIG. 4 illustrates the position of the ducts of the double-flow bypass duct 4 by means of the two dashed semicircles 17 and 18, these two ducts 17 and 18 being separated by means of the partition 19. Moreover, the center of the first duct 17 is indicated by the point M1 and the center of the second duct 18 by the point M2. The line Mₙ designates the center of the fastening head 14, and the dimensions A and B indicate the lever arms resulting from the geometric arrangement of the flap plate 9 with eccentric mounting on the fastening lever 8.

### LIST OF REFERENCE SYMBOLS

1 Turbocharger
2 Turbine casing
4 Bypass duct
5 Exhaust gas outlet
6 Regulating flap/wastegate flap
7 Free end of the spindle 13
8 Fastening lever
9 Flap plate
10 Fastening tenon of the flap plate 9
11 Flattened region of the flap plate 9
13 Spindle
14 Fastening head
15 Free end of the bypass lever 8
16 Reception recess
17 First duct of the bypass duct
18 Second duct of the bypass duct
19 Partition
M1, M2 Centers
Mₙ Center of the fastening head
A, B Lever arms
L Longitudinal axis of the fastening lever 8
□ Angle between the spindle 13 and L

1. A subassembly for bypass control in the turbine casing of a turbocharger, in particular for a diesel engine, consisting of an iron-based alloy with a carbide microstructure and dispersions of at least one rare earth element or compound and/or Y₂O₃.

2. The subassembly for bypass control as claimed in claim 1, wherein the iron-based alloy contains boron and/or zirconium.

3. The subassembly for bypass control as claimed in claim 1, wherein the iron-based alloy contains the elements titanium, tantalum and carbon, their total fraction amounting to about 5 to 10% by weight in relation to the overall alloy.

4. The subassembly for bypass control as claimed in claim 1, wherein the iron-based alloy contains the elements lanthanum and hafnium, their fraction by volume amounting in total to a maximum of about 2% by volume in relation to the overall volume of the alloy.

5. The subassembly for bypass control as claimed in claim 1, wherein the iron-based alloy contains the elements lanthanum, hafnium, boron, yttrium and zirconium.

6. The subassembly for bypass control as claimed in claim 1, wherein the iron-based alloy contains the elements cobalt, chrome, titanium and tantalum, their total fraction amounting to about 22 to 35% by weight in relation to the overall alloy.

7. The subassembly for bypass control as claimed in claim 1, wherein the iron-based alloy contains the following components: C: 0.05 to 0.35% by weight, Cr: 17 to 26% by weight, Ni: 15 to 22% by weight, Co: 15 to 23% by weight, Mo: 1 to 4% by weight, W: 1.5 to 4% by weight, Ta: 1 to 3.5% by weight, Zr: 0.1 to 0.5% by weight, Hf: 0.4 to 1.2% by weight, B: maximum 0.2% by weight, La: maximum 0.25% by weight, Si: maximum 1% by weight, Mn: 1 to 2% by weight, Nb: 0.5 to 2% by weight, Ti: 1 to 2.5% by weight, N: 0.1 to 0.5% by weight, the sum of S and P: less than 0.04% by weight, and Fe.

8. The subassembly for bypass control as claimed in claim 1, wherein the iron-based alloy contains the following components: C: 0.05 to 0.35% by weight, Cr: 17 to 26% by weight, Ni: 15 to 22% by weight, Co: 15 to 23% by weight, Mo: 1 to 4% by weight, W: 1.5 to 4% by weight, Ta: 1 to 3.5% by weight, Zr: 0.1 to 0.5% by weight, Y₂O₃: 0.4 to 1.5% by weight, Ti: 1.5 to 3% by weight, Si: maximum 1% by weight, Mn: 0.8 to 2.5% by weight, Nb: 0.5 to 1.7% by weight, N: 0.05 to 0.5% by weight, the sum of S and P: less than 0.05% by weight, and Fe.

9. The subassembly for bypass control as claimed in claim 1, wherein the iron-based alloy is free of sigma phases.

10. An exhaust gas turbocharger, in particular for diesel engines, comprising a subassembly for bypass control in the turbine casing of the turbocharger, consisting of an iron-based alloy with a carbide microstructure and dispersions of at least one rare earth element or compound and/or Y₂O₃.

11. The exhaust gas turbocharger as claimed in claim 10, wherein the iron-based alloy contains boron and/or zirconium.

12. The exhaust gas turbocharger as claimed in claim 1, wherein the iron-based alloy contains the elements titanium, tantalum and carbon, their total fraction amounting to about 5 to 10% by weight in relation to the overall alloy.

13. The exhaust gas turbocharger as claimed in claim 10, wherein the iron-based alloy contains the elements lanthanum and hafnium, their fraction by volume amounting in total to a maximum of about 2% by volume in relation to the overall volume of the alloy.

14. The exhaust gas turbocharger as claimed in claim 10, wherein the iron-based alloy contains the elements lanthanum, hafnium, boron, yttrium and zirconium.

15. The exhaust gas turbocharger as claimed in claim 10, wherein the iron-based alloy contains the elements cobalt, chrome, titanium and tantalum, their total fraction amounting to about 22 to 35% by weight in relation to the overall alloy.

16. The exhaust gas turbocharger as claimed in claim 10, wherein the iron-based alloy contains the following components: C: 0.05 to 0.35% by weight, Cr: 17 to 26% by weight, Ni: 15 to 22% by weight, Co: 15 to 23% by weight, Mo: 1 to 4% by weight, W: 1.5 to 4% by weight, Ta: 1 to 3.5% by weight, Zr: 0.1 to 0.5% by weight, Hf: 0.4 to 1.2% by weight, B: maximum 0.2% by weight, La: maximum 0.25% by weight, Si: maximum 1% by weight, Mn: 1 to 2% by weight, Nb: 0.5 to 2% by weight, Ti: 1 to 2.5% by weight, N: 0.1 to 0.5% by weight, the sum of S and P: less than 0.04% by weight, and Fe.

17. The exhaust gas turbocharger as claimed in claim 10, wherein the iron-based alloy contains the following components: C: 0.05 to 0.35% by weight, Cr: 17 to 26% by weight, Ni: 15 to 22% by weight, Co: 15 to 23% by weight, Mo: 1 to 4% by weight, W: 1.5 to 4% by weight, Ta: 1 to 3.5% by weight, Zr: 0.1 to 0.5% by weight, Y₂O₃: 0.4 to 1.5% by weight, Ti: 1.5 to 3% by weight, Si: maximum 1% by weight, Mn: 0.8 to 2.5% by weight, Nb: 0.5 to 1.7% by weight, N: 0.05 to 0.5% by weight, the sum of S and P: less than 0.05% by weight, and Fe.

18. The exhaust gas turbocharger as claimed in claim 10, wherein the iron-based alloy is free of sigma phases.
